(19) United States
(12) Patent Application Publication
(10) Pub. No.: US 2020/0208767 A1
(43) Pub. Date: Jul. 2, 2020

(54) FLEXIBLE COUPLING ELEMENT WITH TOLERANCE COMPENSATION FOR FLEXIBLY CONNECTING TWO MEDIA-GUIDING ELEMENTS

(71) Applicant: ContiTech MGW GmbH, Hannoversch Muenden (DE)

(72) Inventors: Axel Flach, Bad Wildungen (DE); Harald Kreidner, Hannoversch Muenden (DE)

(73) Assignee: ContiTech MGW GmbH, Hannoversch Muenden (DE)

(21) Appl. No.: 16/634,156

(22) PCT Filed: May 3, 2018
(86) PCT No.: PCT/EP2018/061254

§ 371 Date: Jan. 26, 2020

(30) Foreign Application Priority Data
Jul. 27, 2017 (DE) 10 2017 212 907.7

(51) Int. Cl. F16L 37/52; F16L 37/50; F16L 37/14

(52) U.S. Cl. CPC F16L 37/52; F16L 2201/10; F16L 37/144; F16L 37/505

(57) ABSTRACT

Coupling element (1) with tolerance compensation for flexibly connecting two elements for guiding media, having two components (2, 3), which can be connected captively to each other in a fluid-guiding manner, wherein a translational, rotational or cardanically tilting movement of the first component (2) against the second component (3) is possible. The invention therefore addressed the problem of improving a tolerance-compensating coupling element (1) of the kind described at the outset in such a way that materials with high strength but low elasticity demands can be used. This problem is solved by the fact that the captive connection (7, 8) has a slotted snap ring (8) that engages through an opening (6) of the first component (2) and behind a bead (7) of the second component (3), thereby preventing the two components (2, 3) from being completely pulled apart.

The invention relates to a coupling element with tolerance compensation for flexibly connecting two elements for guiding media, in particular one pipe or hose to another pipe or hose or to an assembly, having a first component for connection to the first element, and a second component for connection to the second element, wherein the first component and the second component have a device for captive connection, and the first component and the second component have a common longitudinal direction, and the first component and the second component can be moved in translation relative to one another in the direction of the common longitudinal direction, and/or that the first component and the second component are rotatable relative to one another about the common longitudinal direction, and/or the first component and the second component are tiltable cardanically relative to one another, perpendicularly to the common longitudinal direction.

In order to transport media, such as, for example, fluids, gases or else pasty media, use is made of, for example, lines, hoses, pipes, etc. These can be attached to one another or, for example, to assemblies in order to realize the flow of media. For example, in the automobile sector, fluids, such as, for example, fuels, oils, additional substances (AdBlue®) and coolants or gases, such as, for example, charge air are conducted in such a manner.

Couplings are used in order to produce this connection or this attachment. Said couplings serve for the secure, permanent and media-tight connection of the elements.

On account of the manufacturing, the course of said lines is subject to tolerances of a greater or lesser size, which may be permissible depending on the application, for example the installation space in the vehicle. Use can therefore be made of lines which lie within the smallest and largest sizes of the tolerances of the application.

Depending on the application, the size of the tolerances is determined in such a way as to ensure that the course of the line is not impaired by the permissible tolerances, for example by collision with neighboring components. Moreover, despite the permissible tolerances, the fastening points (points of support) for the line must be maintained in order to ensure that they coincide with the mating positions (screw attachment points), e.g. on the engine.

DE 10 2014 211 844 A1 discloses a coupling element of the type in question which has a latching connection for the captive connection. The latching is based here on latching elements which can be snapped into place. Said latching elements have to have a certain elasticity with a simultaneously high strength so that they do not break as they are being snapped into place. For this purpose, relatively high-quality materials are necessary, for example glass fiber-reinforced PA 6.6, which leads to considerable costs since the entire coupling element is produced from this material although a corresponding elasticity with a high strength is necessary only for the latching elements.

The invention therefore addressed the problem of improving a tolerance-compensating coupling element of the kind described at the outset in such a way that materials with high strength but low elasticity demands can be used.

This problem is solved by virtue of the fact that the captive connection has a snap ring and the first component has at least one at least partially radially encircling opening corresponding to the snap ring, and the second component has at least one at least partially radially encircling bead, wherein, in the assembled state of the connection, the snap ring engages through the opening of the first component and comes to rest in such a way behind the bead of the second component that a translational, rotational or cardanically tilting movement of the first component against the second component is possible but the two components are prevented from being completely pulled apart.

This arrangement has the advantage that no latching projections are required. A corresponding elasticity of the component is therefore unnecessary, and thus there are no special elasticity demands, despite the high-strength materials.

In a development of the invention, the snap ring is designed in such a way that it can be elastically deformed radially outward and removed from the opening of the first component.

This design has the advantage that the connection between the first and the second component can be released again.

In a development of the invention, the second component has at least one further opening, through which the correct fit of the snap ring can be observed.

In this way, reliable locking of the coupling element can be checked without problems.

An exemplary embodiment of the invention will be discussed in more detail below on the basis of the drawing.

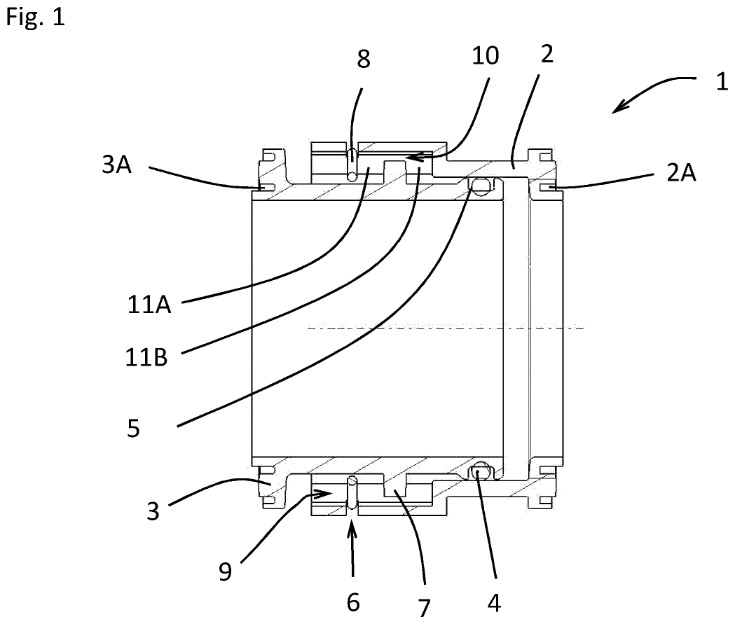

FIG. 1 shows a longitudinal section through a coupling element 1 according to the invention in a fully assembled state. The coupling element 1 has a first component 2 and a second component 3. Each of the two components 2 and 3 has a connection point 2A, 3A for connection to further fluid-guiding elements (not shown here).

An O ring seal 4 which ensures the leaktightness of the connection between the first component 2 and the second component 3 is arranged in a groove 5 between the first and the second component 2, 3.

The first component 2 has an approximately slot-shaped, at least partially radially encircling opening 6.

The second component 3 has a radially outward-facing, radially at least partially encircling bead 7, which is interrupted circumferentially in such a way, in a manner that is not visible here, that a knobbed profile of the bead 7 is obtained in the circumferential direction.

A resilient snap ring 8, which is of metallic design in this case, engages through the opening 6 of the first component 2 and, in the process, comes to rest behind the bead 7 of the second component.

The first component 2 has a region 9 which engages around the bead 7 of the second component and is spaced apart from the bead 7 with a clearance 10 in the radial direction and a clearance 11A and 11B in the axial direction. The clearances 10 and 11A and 11B ensure that the first component 2 is capable of a movement against the second component 3 in translation, in rotation and/or in a cardanically tilting manner.

By virtue of the fact that the snap ring 8 comes to rest behind the bead 7 of the second component through the opening 6 of the first component 2, the components 2, 3 can be pulled apart only in the region of clearance 11A, thus ensuring that the components 2 and 3 are connected to one another in a captive manner.

### LIST OF REFERENCE SIGNS

### Part of the Description

1 Coupling element
2 First component of the coupling element 1
2A Connection point of the first component 2
3 Second component of the coupling element 1
3A Connection point of the second component 3
4 O ring seal
5 Groove
6 Opening in the first component 2
7 Bead of the second component 3
8 Slotted snap ring
9 Region of the first component
10 Radial clearance
11A, 11B Axial clearance

1.-3. (canceled)

4. A coupling element with tolerance compensation for flexibly connecting two elements for guiding media, in particular one pipe or hose to another pipe or hose or to an assembly, having a first component for connection to the first element, and a second component for connection to the second element, wherein the first component and the second component have a device for captive connection, and the first component and the second component have a common longitudinal direction, and the first component and the second component can be moved in translation relative to one another in the direction of the common longitudinal direction, and/or that the first component and the second component are rotatable relative to one another about the common longitudinal direction, and/or the first component and the second component are tiltable cardanically relative to one another, perpendicularly to the common longitudinal direction,
wherein the captive connection has a slotted snap ring and the first component has at least one at least partially radially encircling opening corresponding to the snap ring, and the second component has at least one at least partially radially encircling bead, wherein, in the assembled state of the connection, the snap ring engages through the opening of the first component and comes to rest in such a way behind the bead of the second component that a translational, rotational or cardanically tilting movement of the first component against the second component is possible but the two components are prevented from being pulled apart.

5. The coupling element as claimed in claim 4, wherein the snap ring is designed that it can be elastically deformed radially outward and removed from the opening of the first component.

6. The coupling element as claimed in claim 4, wherein the second component has at least one further opening, through which the correct fit of the snap ring can be observed.

7. The coupling element as claimed in claim 4, wherein the snap ring is designed that it can be elastically deformed radially outward and removed from the opening of the first component and the second component has at least one further opening, through which the correct fit of the snap ring can be observed.

8. The coupling element of claim 1, wherein the snap ring is metallic.

9. The coupling element of claim 1, wherein the first component has a region which engages around the bead of the second component and is spaced apart from the bead with a radial clearance in the radial direction.

10. The coupling element of claim 1, wherein the first component has a region which engages around the bead of the second component and is spaced apart from the bead with a first and second axial clearance in the axial direction.

11. A coupling element with tolerance compensation for guiding media, the coupling element comprising:
a first component having a slot-shaped radially encircling opening;
a second component having a radially outward-facing and encircling bead and is interrupted circumferentially to have a knobbed profile of the bead in the circumferential direction;
wherein the first component and the second component have a common longitudinal direction and are rotatable relative to one another about the common longitudinal direction;
an O ring seal arranged in a groove of the second component and between the first component and the second component, wherein the O ring seal is configured to ensure a leaktight connection between the first component and the second component;
a metallic, resilient snap ring configured to engage the opening of the first component and rest behind the bead of the second component; and
wherein the first component further includes a region that engages around the bead of the second component and is spaced apart from the bead with a radial clearance in the radial direction and first and second axial clearances in the axial direction.

12. The coupling element of claim 11, wherein the first axial clearance is between the opening of the first component and the bead of the second component and the second axial clearance with between the bead of the second component and an interior surface of the first coupling element.

13. The coupling element of claim 12, wherein the first axial clearance permits slight relative movement between the first component and the second component in a first longitudinal direction and the second axial clearance permits slight relative movement between the first component and the second component in a second longitudinal direction that is different than the first longitudinal direction.

14. The coupling element of claim 12, wherein the radial clearance, the first axial clearance and the second axial clearance combine to provide movement and rotation between the first component and the second component in a cardanically tilting manner and provide tolerance compensation.

15. The coupling element of claim 11, wherein the first component comprises a first portion configured to accept the O ring seal and a second portion configured to accept the bead of the second component.

16. The coupling element of claim 11, wherein the snap ring is removable to permit movement of the bead of the second component relative to the first component in an away longitudinal direction and facilitate separation of the first component and the second component.

17. The coupling element of claim 11, wherein the first component is configured to transfer media with the second component.

18. The coupling element of claim 17, wherein the media is oil.

19. The coupling element of claim 17, wherein the media is coolant.
